(19) United States
(12) Patent Application Publication
(10) Pub. No.: US 2020/0055446 A1
(43) Pub. Date: Feb. 20, 2020

(54) REAR WHEEL POSITION INDICATOR

(71) Applicant: MITSUBISHI ELECTRIC CORPORATION, Tokyo (JP)

(72) Inventors: Sayuri FUKANO, Tokyo (JP); Yoshinori SAIKAWA, Tokyo (JP)

(73) Assignee: MITSUBISHI ELECTRIC CORPORATION, Tokyo (JP)

(21) Appl. No.: 16/609,682

(22) PCT Filed: Jun. 21, 2017
(86) PCT No.: PCT/JP2017/022848

§ 371 Date: Oct. 30, 2019

(51) Int. Cl. B60Q 1/48; B60Q 1/30

(52) U.S. Cl. CPC B60Q 1/48; B60Q 1/30

(57) ABSTRACT

A light emitting unit for irradiating a road surface on a side of a rear wheel of a vehicle with light is included. A light irradiation area by the light emitting unit is at least a planar area extending in the front-rear direction of the vehicle. This allows a driver to visually recognize the position of the rear wheel of the vehicle.

### TECHNICAL FIELD

The present invention relates to a rear wheel position indicator for irradiating a road surface on a side of a rear wheel of a vehicle with light.

### BACKGROUND ART

Patent Literature 1 below discloses an apparatus for irradiating a road surface on a side of a vehicle with laser light in order to assist parking of the vehicle.

### CITATION LIST

### Patent Literatures

Patent Literature 1: JP 2008-179253 A

### SUMMARY OF INVENTION

### Technical Problem

For example, a driver of a large vehicle such as a truck may need to confirm a positional relationship between a rear wheel of a vehicle and a curb or the like on a road in order to ensure safety when turning left or right.

A laser light irradiation area by the parking assistance device disclosed in Patent Literature 1 is roughly the entire side of a vehicle from a front bumper of the vehicle to a rear bumper thereof. For this reason, a driver cannot confirm the position of a rear wheel of the vehicle even by looking at the laser light irradiation area through a side mirror or the like disadvantageously.

The present invention has been achieved in order to solve the problem as described above, and an object of the present invention is to obtain a rear wheel position indicator that can allow a driver to visually recognize the position of a rear wheel of a vehicle.

### Solution to Problem

A rear wheel position indicator according to the present invention includes a light emitting unit for irradiating a road surface on a side of a rear wheel of a vehicle with light. A light irradiation area by the light emitting unit is at least a planar area extending in the front-rear direction of the vehicle.

### Advantageous Effects of Invention

According to the present invention, the light irradiation area of a road surface on a side of a rear wheel of a vehicle is at least a planar area extending in the front-rear direction of the vehicle. Therefore, a driver is allowed to visually recognize the position of the rear wheel of the vehicle.

### BRIEF DESCRIPTION OF DRAWINGS

FIG. 1 is a configuration diagram illustrating a rear wheel position indicator according to a first embodiment of the present invention.

FIG. 2 is a hardware configuration diagram illustrating the rear wheel position indicator according to the first embodiment of the present invention.

FIG. 3 is a hardware configuration diagram illustrating a control system of a vehicle including the rear wheel position indicator.

FIG. 4 is a flowchart illustrating processing details of the rear wheel position indicator according to the first embodiment of the present invention.

FIG. 5 is an explanatory diagram illustrating an example in which a road surface on a side of a right rear wheel of a vehicle is irradiated with light.

FIG. 6 is an explanatory diagram illustrating a height H of a side mirror from a road surface and a distance L from the side mirror to a rear wheel in the front-rear direction.

FIG. 7 is an explanatory diagram illustrating an example in which a light irradiation area is a linear area extending in the left-right direction of a vehicle but not extending in the front-rear direction of the vehicle.

FIG. 8 is an explanatory diagram illustrating an example in which a light irradiation area is an area extending in the front-rear direction of a vehicle but not extending in the left-right direction of the vehicle.

FIG. 9A is an explanatory diagram illustrating the shape of a light irradiation area when a driver looks at the light irradiation area through a side mirror when a curb is not irradiated with light. FIG. 9B is an explanatory diagram illustrating the shape of a light irradiation area when a driver looks at the light irradiation area through a side mirror, and when a curb is irradiated with light.

FIG. 10 is an explanatory diagram illustrating an example of a vehicle having a marker light mounted on a side surface thereof.

FIG. 11 is a configuration diagram illustrating a rear wheel position indicator according to a second embodiment of the present invention.

FIG. 12 is a hardware configuration diagram illustrating the rear wheel position indicator according to the second embodiment of the present invention.

FIG. 13 is an explanatory diagram illustrating an example of a change in shape in a light irradiation area.

### DESCRIPTION OF EMBODIMENTS

Hereinafter, in order to describe the present invention in more detail, an embodiment for carrying out the present invention will be described with reference to the attached drawings.

### First Embodiment

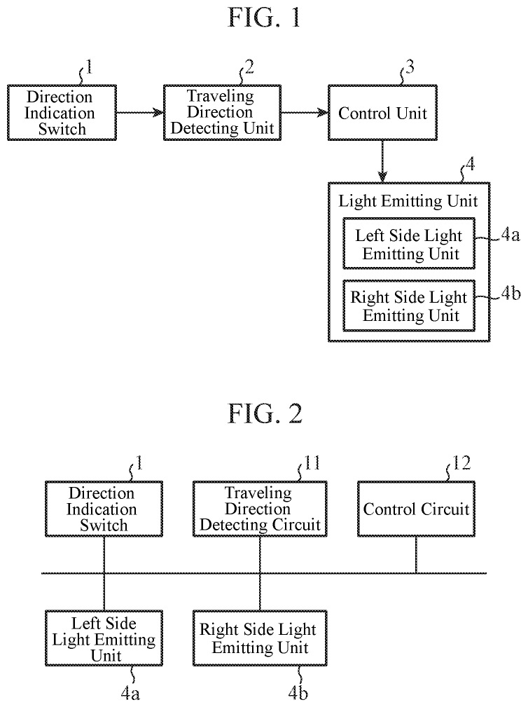

FIG. 1 is a configuration diagram illustrating a rear wheel position indicator according to a first embodiment of the present invention. FIG. 2 is a hardware configuration diagram illustrating the rear wheel position indicator according to the first embodiment of the present invention.

In FIGS. 1 and 2, a direction indication switch 1 receives operation of a blinker 65 by a driver when a vehicle turns left or right.

A traveling direction detecting unit 2 is achieved by, for example, a traveling direction detecting circuit 11 illustrated in FIG. 2.

The traveling direction detecting unit 2 detects a traveling direction of a vehicle from operation received by the direction indication switch 1.

A control unit 3 is achieved by, for example, a control circuit 12 illustrated in FIG. 2.

If the traveling direction detected by the traveling direction detecting unit 2 is the left direction, the control unit 3 outputs an instruction to irradiate a road surface on a side of a left rear wheel of a vehicle with light to the light emitting unit 4. If the traveling direction detected by the traveling direction detecting unit 2 is the right direction, the control unit 3 outputs an instruction to irradiate a road surface on a side of a right rear wheel of the vehicle with light to the light emitting unit 4.

The light emitting unit 4 includes a left side light emitting unit 4a and a right side light emitting unit 4b.

The left side light emitting unit 4a is disposed, for example, near a tire house of a left rear wheel, and is a lighting device for emitting laser light, light emitting diode (LED) light, or the like.

When the control unit 3 outputs an instruction to irradiate a road surface on a side of a left rear wheel with light, the left side light emitting unit 4a irradiates the road surface on the side of the left rear wheel of the vehicle with light.

The right side light emitting unit 4b is disposed, for example, near a tire house of a right rear wheel, and is a lighting device for emitting laser light, LED light, or the like.

A light irradiation area by the left side light emitting unit 4a and a light irradiation area by the right side light emitting unit 4b are each a planar area extending in the front-rear direction of a vehicle and extending in the left-right direction of the vehicle.

The first embodiment will describe an example in which the light irradiation area is a planar area, but the light irradiation area only needs to be extended at least in the front-rear direction of a vehicle, and may have a short length in the left-right direction of the vehicle.

In FIG. 1, it is assumed that each of the traveling direction detecting unit 2 and the control unit 3 which are constituent elements of the rear wheel position indicator is achieved by dedicated hardware as illustrated in FIG. 2. That is, it is assumed that the traveling direction detecting unit 2 and the control unit 3 are achieved by the traveling direction detecting circuit 11 and the control circuit 12, respectively.

For example, a single circuit, a composite circuit, a programmed processor, a parallel programmed processor, an application specific integrated circuit (ASIC), a field-programmable gate array (FPGA), an electronic control unit (ECU), or a combination thereof corresponds to each of the traveling direction detecting circuit 11 and the control circuit 12.

The traveling direction detecting unit 2 and the control unit 3 which are constituent elements of the rear wheel position indicator are not limited to those achieved by dedicated hardware, and the traveling direction detecting unit 2 and the control unit 3 may be achieved by software, firmware, or a combination of software and firmware.

Software or firmware is stored as a program in a memory of a computer. The term “computer” is intended to mean hardware for executing a program. For example, a central processing unit (CPU), a central processing device, a processing device, an arithmetic device, a microprocessor, a microcomputer, a processor, or a digital signal processor (DSP) corresponds thereto.

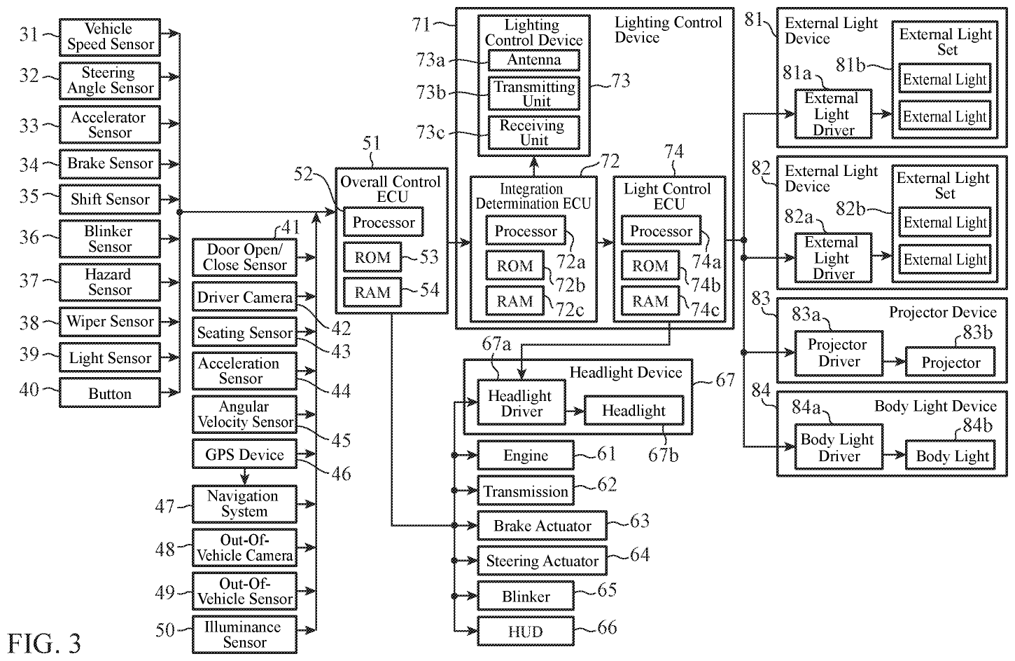

FIG. 3 is a hardware configuration diagram illustrating a control system of a vehicle including the rear wheel position indicator.

FIG. 3 illustrates an example in which the traveling direction detecting unit 2 and the control unit 3 which are constituent elements of the rear wheel position indicator are achieved by software, firmware, or the like.

In FIG. 3, a vehicle speed sensor 31 detects a speed of a vehicle, and outputs a vehicle speed pulse which is an electrical signal corresponding to a rotation speed of a wheel to an overall control ECU 51.

A steering angle sensor 32 detects a steering angle of a vehicle, and outputs an electrical signal corresponding to the steering angle to the overall control ECU 51.

An accelerator sensor 33 detects the amount of operation of an accelerator pedal as the degree of opening of an accelerator, and outputs operation amount information indicating the amount of operation of the accelerator pedal to the overall control ECU 51.

A brake sensor 34 detects the amount of operation of a brake pedal, and outputs operation amount information indicating the amount of operation of the brake pedal to the overall control ECU 51.

A shift sensor 35 detects a current state of a shift lever or a change in the state of the shift lever, and outputs operation information of the shift lever by a driver to the overall control ECU 51.

A blinker sensor 36 detects operation of the direction indication switch 1 by a driver, and outputs operation information of the direction indication switch 1 to the overall control ECU 51.

A hazard sensor 37 detects operation of a hazard switch by a driver, and outputs operation information of the hazard switch by the driver to the overall control ECU 51.

A wiper sensor 38 detects operation of a wiper by a driver, and outputs operation information of the wiper by the driver to the overall control ECU 51.

A light sensor 39 detects operation of a light lever by a driver, and outputs operation information of the light lever by the driver to the overall control ECU 51.

A button 40 receives start or end of light irradiation, and is disposed, for example, near a steering wheel. When the button 40 is pressed down, a control signal instructing start or end of light irradiation is output to the overall control ECU 51.

Here, an example in which the button 40 outputs a control signal instructing start or end of light irradiation to the overall control ECU 51 is illustrated, but the present invention is not limited thereto. For example, the button 40 may output a control signal to an integration determination ECU 72 of a lighting control device 71.

A door open/close sensor 41 detects open/close of a door of a vehicle, and outputs open/close information of the door to the overall control ECU 51.

A driver camera 42 is an imaging device disposed facing a driver's seat of a vehicle, takes an image of a driver sitting on the driver's seat, and outputs the taken image to the overall control ECU 51.

A seating sensor 43 is achieved by, for example, a pressure sensor disposed on a seat of a vehicle, and detects a seating condition of a user such as a driver. The seating sensor 43 outputs information indicating a seating condition of a user to the overall control ECU 51 when the user is seated or away from the seat. A plurality of the seating sensors 43 may be disposed on a seat. The overall control ECU 51 may estimate the posture or the like of a user on the basis of information output from the plurality of seating sensors 43.

An acceleration sensor 44 detects the acceleration of a vehicle, and is achieved by, for example, a triaxial acceleration sensor. The acceleration sensor 44 outputs acceleration information indicating the acceleration of a vehicle to the overall control ECU 51.

An angular velocity sensor 45 detects the angular velocity of a vehicle, and outputs angular velocity information indicating the angular velocity of the vehicle to the overall control ECU 51. The overall control ECU 51 can detect a turning speed or the like of a vehicle from the angular velocity information.

A GPS device 46 receives a radio wave transmitted from an artificial satellite in a global positioning system and detects the position of a host vehicle, and outputs coordinates indicating the position of the host vehicle to the overall control ECU 51 and a navigation system 47.

The navigation system 47 has map information, and has a function of calculating a recommended route to a destination of the vehicle on the basis of the position of the vehicle and the map information. Furthermore, the navigation system 47 has a communication function, can acquire external information such as congestion information or stoppage information from a server, and can calculate a recommended route on the basis of the external information.

Furthermore, the navigation system 47 has a function of transmitting vehicle position information, destination information, and the like to a server, and may be formed as a system for receiving information of a recommended route calculated on the server side.

The navigation system 47 outputs route information indicating the recommended route to the overall control ECU 51.

An-vehicle camera 48 is an imaging device disposed for imaging the outside of a vehicle.

The out-of-vehicle camera 48 is disposed, for example, on each of the front, rear, left, and right, and outputs an taken image to the overall control ECU 51. The overall control ECU 51 detects or recognizes a human, and also detects or recognizes an obstacle object such as another vehicle on the basis of the image output from the out-of-vehicle camera 48.

The out-of-vehicle sensor 49 detects an object present around the vehicle, and is achieved by, for example, an ultrasonic sensor, a radar sensor, a millimeter wave radar sensor, or an infrared laser sensor.

The out-of-vehicle sensor 49 outputs detection information of an object present around a vehicle to the overall control ECU 51. The overall control ECU 51 can detect a distance from a host vehicle to an object and the position of an object on the basis of the detection information of the object output from the out-of-vehicle sensor 49.

An illuminance sensor 50 detects the illuminance of the outside of a vehicle, and outputs illuminance information indicating the illuminance of the outside to the overall control ECU 51.

The overall control ECU 51 has a function of controlling an entire vehicle, and includes a processor 52, a read only memory (ROM) 53, and a random access memory (RAM) 54.

The overall control ECU 51 receives information output from the vehicle speed sensor 31, the steering angle sensor 32, the accelerator sensor 33, the brake sensor 34, the shift sensor 35, the blinker sensor 36, the hazard sensor 37, the wiper sensor 38, the light sensor 39, and the button 40.

Furthermore, the overall control ECU 51 receives information output from the door open/close sensor 41, the seating sensor 43, the acceleration sensor 44, the angular velocity sensor 45, the GPS device 46, the navigation system 47, the out-of-vehicle sensor 49, and the illuminance sensor 50.

Furthermore, the overall control ECU 51 receives an image output from the driver camera 42 and the out-of-vehicle camera 48.

The overall control ECU 51 executes control of an entire vehicle in such a manner that each part of the vehicle operates appropriately on the basis of received information and image.

The processor 52 is a calculation processing circuit for executing various kinds of calculation processing.

The processor 52 reads a program stored in the ROM 53, develops the program in the RAM 54, and executes calculation processing.

The ROM 53 is a non-volatile storage device for storing one or more programs.

The RAM 54 is a volatile storage device in which a program to be executed by the processor 52, various kinds of information, and the like are developed.

The ROM 53 and the RAM 54 are formed by, for example, a semiconductor memory device, and may be called a memory.

An engine 61 is an internal combustion engine for generating power to drive a vehicle, and generates power to rotate a wheel by burning a fuel such as gasoline. The engine 61 can also operate on the basis of an instruction from the overall control ECU 51.

A transmission 62 is formed by a gear, a shaft, and the like, and has a function of transmitting power generated by the engine 61 to a wheel. The transmission 62 can change a torque transmitted to a wheel by changing a gear on the basis of an instruction from the overall control ECU 51.

A brake actuator 63 is a mechanism for operating a brake for decelerating a vehicle. The brake actuator 63 can operate the brake on the basis of an instruction from the overall control ECU 51 and can decelerate a vehicle.

A steering actuator 64 is a mechanism for changing a direction of a wheel and operating steering for controlling a traveling direction of a vehicle. The steering actuator 64 can control steering on the basis of an instruction from the overall control ECU 51, and can control a traveling direction of a vehicle.

The blinker 65 is a direction indicator for indicating a traveling direction of a vehicle to the outside of the vehicle by light emission, and blinks on the basis of an instruction from the overall control ECU 51.

A head-up display (HUD) 66 is a transmission type image display device disposed so as to be superimposed on a windshield of an automobile, and can display various images on the basis of an instruction from the overall control ECU 51. The HUD 66 can present various information to a user in a vehicle by displaying an image.

A headlight device 67 includes a headlight driver 67a and a headlight 67b.

The headlight driver 67a is a drive device for driving the headlight 67b.

The headlight driver 67a switches between turning on and off the headlight 67b on the basis of an instruction from the overall control ECU 51 or a light control ECU 74, and switches between high beam and low beam of the headlight 67b.

The headlight 67b is disposed on each of the left and right front sides of a vehicle body, and is an irradiation device for irradiating the front of the vehicle body with light by being driven by the headlight driver 67a.

The lighting control device 71 has a function of controlling a light device of a vehicle.

The lighting control device 71 includes the integration determination ECU 72, a wireless communication device 73, and a light control ECU 74, and controls light emitted by the headlight device 67, an external light device 81, an external light device 82, a projector device 83, and a body light device 84.

The integration determination ECU 72 includes a processor 72a, a ROM 72b, and a RAM 72c.

The integration determination ECU 72 determines a condition of a vehicle on the basis of control information output from the overall control ECU 51, and controls the light control ECU 74 according to the determined condition. Furthermore, the integration determination ECU 72 outputs an instruction regarding communication to the wireless communication device 73.

The integration determination ECU 72 has a function of the traveling direction detecting unit 2 in the rear wheel position indicator of FIG. 1, and can detect a traveling direction of a vehicle.

The wireless communication device 73 includes an antenna 73a, a transmitting unit 73b, and a receiving unit 73c.

The wireless communication device 73 performs wireless communication with an external communication device.

The wireless communication device 73 performs inter-vehicle communication with another vehicle, road-to-vehicle communication with a road side device, or communication with a communicable electronic device such as a smartphone or the like carried by a person, using a specific frequency band. This communication may be unique communication using a specific determined frequency band, or communication using a communication standard determined for executing communication between an in-vehicle communication device and an external communication device. For example, this communication may be performed using an existing communication standard such as wireless local area network (LAN), Bluetooth (registered trademark), or Zigbee (registered trademark).

The wireless communication device 73 transmits a wireless signal output from the transmitting unit 73b to another device via the antenna 73a, and the receiving unit 73c receives the wireless signal output from the other device via the antenna 73a.

The light control ECU 74 includes a processor 74a, a ROM 74b, and a RAM 74c.

The light control ECU 74 controls light emitted by the headlight device 67, the external light device 81, the external light device 82, the projector device 83, and the body light device 84 on the basis of control by the integration determination ECU 72.

The light control ECU 74 has a function of the control unit 3 in the rear wheel position indicator of FIG. 1.

For example, if a traveling direction of a vehicle is the left direction, the light control ECU 74 outputs an instruction to irradiate a road surface on a side of a left rear wheel of the vehicle with light to the external light device 81, the external light device 82, the projector device 83, or the body light device 84.

For example, if the traveling direction of the vehicle is the right direction, the light control ECU 74 outputs an instruction to irradiate a road surface on a side of a right rear wheel of the vehicle with light to the external light device 81, the external light device 82, the projector device 83, or the body light device 84.

Furthermore, the light control ECU 74 controls the shape and size of a light irradiation area of a road surface on a side of a left or right rear wheel of a vehicle, and also controls the brightness, color, irradiation time, irradiation timing, and the like of irradiation light.

The external light device 81, the external light device 82, the projector device 83, and the body light device 84 correspond to the light emitting unit 4 in the rear wheel position indicator of FIG. 1.

The external light devices 81 and 82 are irradiation devices attached to a vehicle, and devices for irradiating a road surface or a wall surface around the vehicle with light and transmitting notice of future operation of the vehicle and intention or warning of current or future operation of the vehicle to a user outside the vehicle.

The light control ECU 74 controls a light irradiation area and the like by the external light devices 81 and 82.

The external light device 81 includes an external light driver 81a and an external light set 81b.

The external light device 82 includes an external light driver 82a and an external light set 82b.

The external light drivers 81a and 82a are drive devices for driving the external light sets 81b and 82b, and have a function of controlling irradiation timing and irradiation time of external lights included in the external light sets 81b and 82b, respectively.

Furthermore, the external light drivers 81a and 82a can irradiate any portion of a road surface or a wall surface around a vehicle with any light by operating color filters, shades, light guide mechanisms, and the like included in the external lights.

The external light sets 81b and 82b each include a plurality of external lights as irradiation devices, and emit light under control of the external light drivers 81a and 82a, respectively.

The projector device 83 is an image projecting device attached to a vehicle, and a device for irradiating a road surface or a wall surface around the vehicle with light and transmitting notice of future operation of the vehicle and intention or warning of current or future operation of the vehicle to a user outside the vehicle.

The light control ECU 74 controls a light irradiation area and the like by the projector device 83.

The projector device 83 includes a projector driver 83a and a projector 83b.

The projector driver 83a is a drive device for driving the projector 83b, and has a function of controlling irradiation timing and irradiation time of the projector 83b.

Furthermore, the projector driver 83a can irradiate any portion of a road surface or a wall surface around a vehicle with any light.

The projector 83b emits light under control of the projector driver 83a.

The body light device 84 is a light emitting device attached to a vehicle, and is a device for transmitting notice of future operation of the vehicle and intention or warning of current or future operation of the vehicle to a user outside the vehicle.

The light control ECU 74 controls a light irradiation area and the like by the body light device 84.

The body light device 84 includes a body light driver 84a and a body light 84b.

The body light driver 84a is a drive device for driving the body light 84b, and has a function of controlling irradiation timing and irradiation time of the body light 84b.

Furthermore, the body light driver 84a can irradiate the outside of a vehicle with any light.

The body light 84b is a light emitting device disposed in such a manner that light emitted from an outer surface of a vehicle is exposed, and is formed by, for example, a liquid crystal display (LCD), an LED, or an organic electroluminescence (EL).

Next, operation will be described.

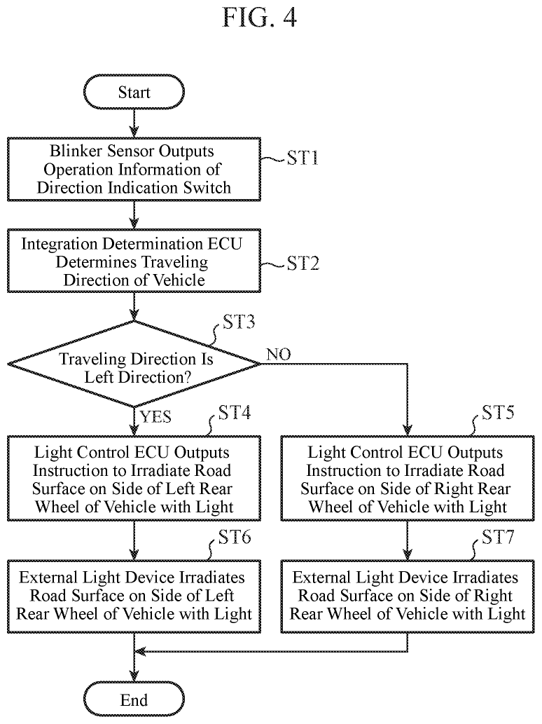

FIG. 4 is a flowchart illustrating processing details of the rear wheel position indicator according to the first embodiment of the present invention.

Hereinafter, processing details of the rear wheel position indicator will be described with reference to FIG. 4.

When a driver operates the direction indication switch 1 in a case where a vehicle turns left or right, the blinker sensor 36 detects the operation of the direction indication switch 1 by the driver, and outputs operation information of the direction indication switch 1 to the overall control ECU 51 (step ST1 in FIG. 4).

When receiving the operation information of the direction indication switch 1 from the blinker sensor 36, the overall control ECU 51 controls blinking of the blinker 65 in accordance with the operation information of the direction indication switch 1.

Furthermore, the overall control ECU 51 outputs control information giving an instruction to irradiate a side of a vehicle with light to the integration determination ECU 72 together with the operation information of the direction indication switch 1.

The integration determination ECU 72 has a function of the traveling direction detecting unit 2 in the rear wheel position indicator of FIG. 1.

When receiving the control information giving an instruction to irradiate a side of a vehicle with light from the overall control ECU 51, the integration determination ECU 72 recognizes that the side of the vehicle is irradiated with light, and determines a traveling direction of the vehicle on the basis of the operation information of the direction indication switch 1 output from the overall control ECU 51 (step ST2 in FIG. 4).

The integration determination ECU 72 outputs an instruction to irradiate a side of the vehicle with light and a determination result of the traveling direction of the vehicle to the light control ECU 74.

The light control ECU 74 has a function of the control unit 3 in the rear wheel position indicator of FIG. 1.

When the light control ECU 74 receives an instruction to irradiate a side of the vehicle with light from the integration determination ECU 72, if the determination result output from the integration determination ECU 72 indicates that the traveling direction of the vehicle is the left direction (YES in step ST3 in FIG. 4), the light control ECU 74 outputs an instruction to irradiate a road surface on a side of a left rear wheel of the vehicle with light to the external light device 81 (step ST4 in FIG. 4).

If the determination result output from the integration determination ECU 72 indicates that the traveling direction of the vehicle is the right direction (NO in step ST3 in FIG. 4), the light control ECU 74 outputs an instruction to irradiate a road surface on a side of a right rear wheel of the vehicle with light to the external light device 81 (step ST5 in FIG. 4).

Here, an example in which the light control ECU 74 outputs an instruction to emit light to the external light device 81 is illustrated, but the present invention is not limited thereto. For example, the light control ECU 74 may output the instruction to emit light to the external light device 82, the projector device 83, or the body light device 84.

When receiving an instruction to irradiate a road surface on a side of a left rear wheel of the vehicle with light from the light control ECU 74, the external light device 81 which is the light emitting unit 4 irradiates the road surface on the side of the left rear wheel of the vehicle with light (step ST6 in FIG. 4).

When receiving an instruction to irradiate a road surface on a side of a right rear wheel of the vehicle with light from the light control ECU 74, the external light device 81 irradiates the road surface on the side of the right rear wheel of the vehicle with light (step ST7 in FIG. 4).

The light control ECU 74 controls the shape and size of a light irradiation area by the external light device 81.

Furthermore, the light control ECU 74 controls the brightness, color, irradiation time, and irradiation timing of light emitted from the external light device 81.

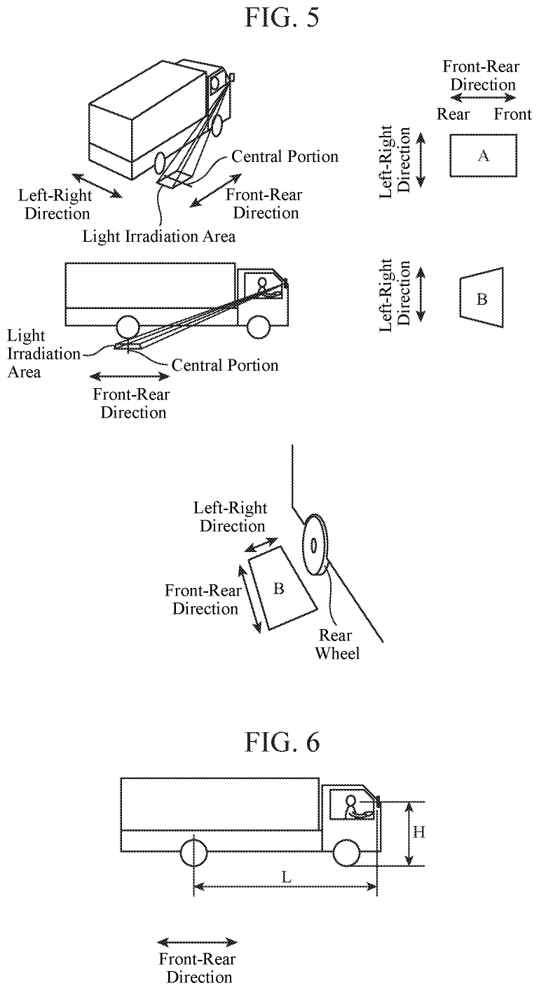

Here, FIG. 5 is an explanatory diagram illustrating an example in which a road surface on a side of a right rear wheel of a vehicle is irradiated with light.

As illustrated in FIG. 5, the light irradiation area is a planar area extending in the front-rear direction of a vehicle and extending in the left-right direction of the vehicle.

Furthermore, light is emitted in such a manner that the central portion of the irradiation area in the front-rear direction corresponds to the position of the axle of the rear wheel.

As a result, a driver of a large vehicle such as a truck can confirm the position of a rear wheel of the vehicle by looking at a light irradiation area by the external light device 81 through a side mirror. For this reason, safety at the time of turning left or right can be enhanced.

Here, FIG. 6 is an explanatory diagram illustrating a height H of a side mirror from a road surface and a distance L from the side mirror to a rear wheel in the front-rear direction.

When a driver looks at a light irradiation area on a side of a rear wheel through a side mirror, the shape of the light irradiation area appears to be deformed by perspective. That is, when a driver looks at a light irradiation area on a side of a rear wheel through a side mirror, the light irradiation area appears to be shorter than the actual length thereof in the front-rear direction. The deformation of the shape due to perspective is larger as the distance L from the side mirror to the rear wheel in the front-rear direction is longer, and is larger as the height H of the side mirror from the road surface is lower.

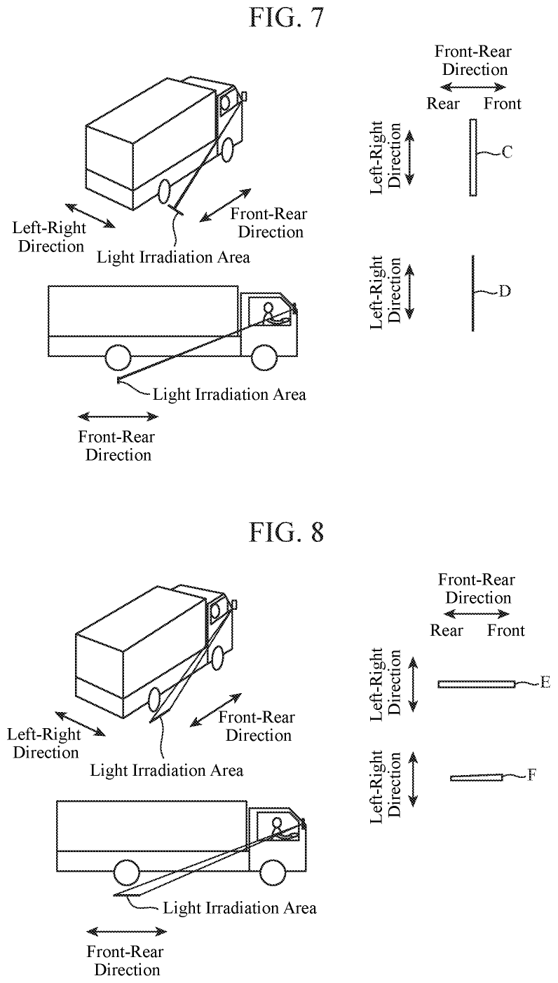

Therefore, in a case where the light irradiation area is a linear area extending in the left-right direction of a vehicle but not extending in the front-rear direction of the vehicle, as illustrated in FIG. 7, the length of the vehicle in the front-rear direction is further shortened, and it is difficult to confirm the light irradiation area.

FIG. 7 is an explanatory diagram illustrating an example in which the light irradiation area is a linear area extending in the left-right direction of a vehicle but not extending in the front-rear direction of the vehicle.

In FIG. 7, a character “C” represents an actual light irradiation area, and a character “D” represents a light irradiation area appearing to be shorter than the actual length by perspective. FIG. 7 illustrates the light irradiation area “D”. However, when the length in the front-rear direction is extremely short, it may be difficult to confirm the light irradiation area.

In the first embodiment, as illustrated in FIG. 5, the light irradiation area is a planar area extending in the front-rear direction of a vehicle and extending in the left-right direction of the vehicle. For this reason, when a driver looks at a light irradiation area on a side of a rear wheel through a side mirror, even if the length of the light irradiation area in the front-rear direction appears to be shorter than the actual length, the length of the light irradiation area in the front-rear direction is secured so as to have a certain length. Therefore, there is no problem in confirming the position of the rear wheel of the vehicle.

In FIG. 5, a character “A” represents an actual light irradiation area, and a character “B” represents a light irradiation area appearing to be shorter than the actual length by perspective.

Furthermore, when a road surface irradiated with light by the external light device 81 is uneven, unevenness occurs in a light irradiation area by the external light device 81.

In the example of FIG. 5, the light irradiation area is a planar area extending in the front-rear direction of the vehicle and extending in the left-right direction of the vehicle. Therefore, there is no problem in confirming the position of the rear wheel of the vehicle even if unevenness occurs in the light irradiation area.

Note that the length of the light irradiation area in the front-rear direction of the vehicle needs to be such a length that a driver can confirm the light irradiation area on a side of the rear wheel through a side mirror. For this reason, the length of the light irradiation area in the front-rear direction of the vehicle depends on the height H of a side mirror from a road surface and the distance L from the side mirror to a rear wheel in the front-rear direction, but is considered to be, for example, the length of the radius of the rear wheel, the length of the diameter of the rear wheel, or about 1.5 times the diameter of the rear wheel.

The first embodiment illustrates an example in which the light irradiation area is a planar area, but the light irradiation area only needs to be extended at least in the front-rear direction of the vehicle, and may have a short length in the left-right direction of the vehicle as illustrated in FIG. 8.

FIG. 8 is an explanatory diagram illustrating an example in which the light irradiation area is an area extending in the front-rear direction of the vehicle but not extending in the left-right direction of the vehicle.

In FIG. 8, a character “E” represents an actual light irradiation area, and a character “F” represents a light irradiation area appearing to be shorter than the actual length by perspective.

Even in a case where the light irradiation area does not extend in the left-right direction of a vehicle, in a case where the light irradiation area extends in the front-rear direction of the vehicle, when a driver looks at a light irradiation area on a side of a rear wheel through a side mirror, even if the length of the light irradiation area in the front-rear direction appears to be shorter than the actual length due to perspective, the length of the light irradiation area in the front-rear direction is secured so as to have a certain length. Therefore, there is no problem in confirming the position of the rear wheel of the vehicle.

FIG. 5 or 8 is illustrated as an example of the light irradiation area applied in the first embodiment. However, the light irradiation area only needs to extend in the front-rear direction of a vehicle. Therefore, the light irradiation area is not limited to the irradiation area illustrated in FIG. 5 or 8. Therefore, the shape of the light irradiation area may be, for example, a circle, an ellipse, a polygon such as a hexagon, or a complex shape such as a star.

In a case where the light irradiation area by the external light device 81 is a planar area as illustrated in FIG. 5, a curb on a road near a vehicle may be irradiated with light emitted by the external light device 81.

In a case where a curb on a road near the vehicle is irradiated with the light emitted by the external light device 81, when a driver looks at a light irradiation area through a side mirror, the shape of the light irradiation area is deformed due to an influence of the curb.

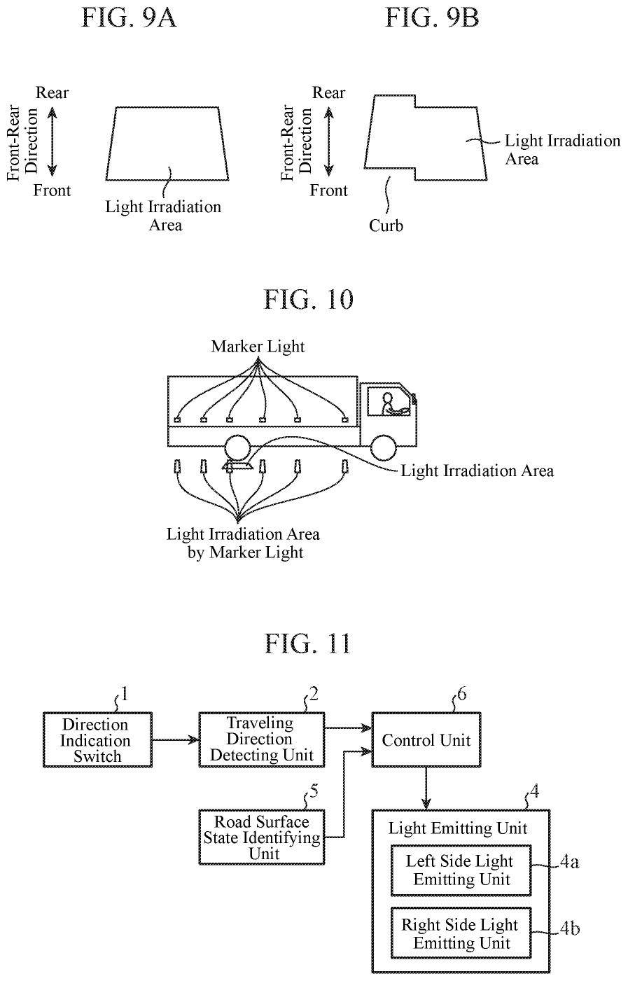

FIG. 9 is an explanatory diagram illustrating a light irradiation area.

FIG. 9A is an explanatory diagram illustrating the shape of a light irradiation area when a driver looks at the light irradiation area through a side mirror when a curb is not irradiated with light. FIG. 9B is an explanatory diagram illustrating the shape of a light irradiation area when a driver looks at the light irradiation area through a side mirror when a curb is irradiated with light.

The shape of the irradiation area is different between a case where a curb is not irradiated with light and a case where a curb is irradiated with light. Therefore, a driver can determine whether or not a side of a vehicle is approaching the curb by recognizing the difference in the shape of the irradiation area.

As apparent from the above, according to the first embodiment, the light emitting unit 4 for irradiating a road surface on a side of a rear wheel of a vehicle with light is included, and the light irradiation area by the light emitting unit 4 is at least a planar area extending in the front-rear direction of the vehicle. Therefore, a driver is allowed to visually recognize the position of the rear wheel of the vehicle.

Furthermore, when a driver looks at a light irradiation area on a side of a rear wheel through a side mirror, even if the length of the light irradiation area in the front-rear direction appears to be shorter than the actual length due to perspective, a driver is allowed to visually recognize the position of the rear wheel of the vehicle.

The first embodiment illustrates an example in which the external light device 81 irradiates a road surface on a side of a rear wheel of a vehicle with light when the blinker sensor 36 detects operation of the direction indication switch 1 by a driver.

However, this is merely an example, and for example, when the button 40 receives start of light irradiation on a side of a rear wheel, the external light device 81 may irradiate a road surface on the side of the rear wheel of the vehicle with light.

For example, in a case where the external light device 81 irradiates a road surface on a side of a rear wheel of the vehicle with light when the button 40 receives start of light irradiation on the side of the rear wheel, not only safety when turning left or right can be enhanced, but also safety in a situation where traveling of the vehicle meanders due to, for example, an S-shaped road can be enhanced.

In this case, the button 40 outputs reception information indicating whether the light of which irradiation start has been received is a light on a side of a left rear wheel of the vehicle or a light on a side of a right rear wheel of the vehicle to the integration determination ECU 72 via the overall control ECU 51.

When receiving the reception information from the button 40 via the overall control ECU 51, the integration determination ECU 72 recognizes that a side of the vehicle is irradiated with light, and transfers the reception information to the light control ECU 74.

If the reception information transferred from the integration determination ECU 72 indicates that irradiation start of the light on a side of a left rear wheel of the vehicle has been received, the light control ECU 74 outputs an instruction to irradiate a road surface on the side of the left rear wheel of the vehicle to the external light device 81.

If the reception information transferred from the integration determination ECU 72 indicates that irradiation start of the light on a side of a right rear wheel of the vehicle has been received, the light control ECU 74 outputs an instruction to irradiate a road surface on the side of the right rear wheel of the vehicle to the external light device 81.

When receiving the instruction to irradiate the road surface on the side of the left rear wheel of the vehicle with light from the light control ECU 74, the external light device 81 irradiates the road surface on the side of the left rear wheel of the vehicle with light.

When receiving the instruction to irradiate the road surface on the side of the right rear wheel of the vehicle with light from the light control ECU 74, the external light device 81 irradiates the road surface on the side of the right rear wheel of the vehicle with light.

The first embodiment illustrates an example in which the external light device 81 irradiates a road surface on a side of a rear wheel of a vehicle with light when the blinker sensor 36 detects operation of the direction indication switch 1 by a driver or the button 40 receives irradiation start of light on a side of the rear wheel.

However, this is merely an example. Therefore, for example, when the steering angle of a vehicle detected by the steering angle sensor 32 is equal to or larger than a set angle, or when the state of a shift lever detected by the shift sensor 35 is R (back), the external light device 81 may irradiate a road surface on a side of a rear wheel of the vehicle with light.

Note that a large vehicle such as a truck may have a marker light mounted on a side surface of the vehicle as illustrated in FIG. 10 in order to make it possible for a driver to grasp the length of the vehicle in the front-rear direction.

Only six marker lights are mounted in FIG. 10 for simplification of the drawing, but actually, six or more marker lights may be mounted.

A road surface is irradiated with light by the marker lights, but it is assumed that a light irradiation area by each of the marker lights will be a long linear area in the horizontal direction of the vehicle as illustrated in FIG. 10.

In the example of FIG. 10, a light irradiation area by the external light device 81 which is the light emitting unit 4 partially overlaps with a light irradiation area by one marker light.

However, the light irradiation area by the external light device 81 is a planar area, and the shape of the light irradiation area by the external light device 81 is different from the shape of the light irradiation area by each of the marker lights. For this reason, the light irradiation area by the external light device 81 can be easily distinguished from the light irradiation area by each of the marker lights even if the light irradiation areas partially overlap with each other.

The first embodiment illustrates an example in which the external light device 81 emits light in the left-right direction of a vehicle which is a direction orthogonal to the front-rear direction of the vehicle.

When the vehicle is a special vehicle in which the angle of a rear wheel changes, the direction of light emitted by the external light device 81 may be switched in accordance with the angle of the rear wheel. For example, if the steering angle of the rear wheel is θ, a form in which the direction of the light emitted by the external light device 81 is set to θ+90 degrees is considered. In this form, if the steering angle of the rear wheel satisfies θ=0 degrees, the external light device 81 emits light in the left-right direction of the vehicle which is a direction orthogonal to the front-rear direction of the vehicle.

### Second Embodiment

A second embodiment will describe an example in which light with which a road surface is irradiated is switched in accordance with the state of the road surface.

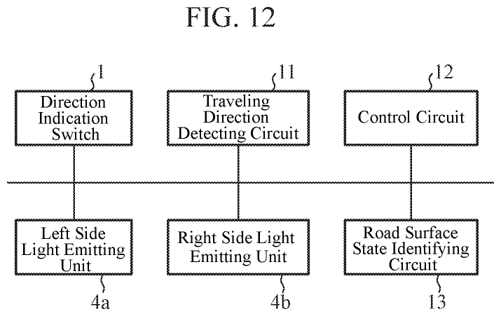

FIG. 11 is a configuration diagram illustrating a rear wheel position indicator according to the second embodiment of the present invention. FIG. 12 is a hardware configuration diagram illustrating the rear wheel position indicator according to the second embodiment of the present invention.

In FIGS. 11 and 12, the same reference numerals as in FIGS. 1 and 2 indicate the same or corresponding parts, and therefore description thereof is omitted.

A road surface state identifying unit 5 is achieved by, for example, a road surface state identifying circuit 13 illustrated in FIG. 12.

The road surface state identifying unit 5 monitors, for example, an image taken by an out-of-vehicle camera 48, and performs processing for identifying the state of a road surface.

A control unit 6 is achieved by, for example, a control circuit 12 illustrated in FIG. 12.

As in the control unit 3 of FIG. 1, if a traveling direction detected by a traveling direction detecting unit 2 is the left direction, the control unit 6 outputs an instruction to irradiate a road surface on a side of a left rear wheel of a vehicle with light to a light emitting unit 4. If the traveling direction detected by the traveling direction detecting unit 2 is the right direction, the control unit 6 outputs an instruction to irradiate a road surface on a side of a right rear wheel of the vehicle with light to the light emitting unit 4.

Furthermore, the control unit 6 outputs an instruction to switch light with which a road surface is irradiated in accordance with the state of the road surface identified by the road surface state identifying unit 5 to the light emitting unit 4.

In the second embodiment, the integration determination ECU 72 has functions of the traveling direction detecting unit 2 and the road surface state identifying unit 5 in a rear wheel position indicator of FIG. 11.

Furthermore, a light control ECU 74 has a function of the control unit 6 in the rear wheel position indicator of FIG. 11.

Next, operation will be described.

The out-of-vehicle camera 48 images a road surface on a side of a rear wheel of a vehicle, and outputs the taken image to an overall control ECU 51.

The overall control ECU 51 transfers the image output from the out-of-vehicle camera 48 to the integration determination ECU 72.

The integration determination ECU 72 has functions of the traveling direction detecting unit 2 and the road surface state identifying unit 5 in the rear wheel position indicator of FIG. 11.

When receiving transfer of the image taken by the out-of-vehicle camera 48 from the overall control ECU 51, the integration determination ECU 72 identifies the state of the road surface from the image.

For example, the color or lightness of the road surface is specified from the image, and presence or absence of snow and presence or absence of water wetness are identified as the state of the road surface from the color or lightness of the road surface.

Here, an example is illustrated in which the integration determination ECU 72 identifies the state of the road surface on the basis of the image taken by the out-of-vehicle camera 48, but the present invention is not limited thereto. For example, the state of the road surface may be identified using a detection result of raindrops by a raindrop sensor or the illuminance detected by an illuminance sensor 50.

Furthermore, as the state of the road surface, in addition to the presence or absence of snow and the presence or absence of water wetness, presence or absence of pavement may be identified.

The integration determination ECU 72 outputs the identification result of the state of the road surface to the light control ECU 74.

The light control ECU 74 has a function of the control unit 6 in the rear wheel position indicator of FIG. 11.

When receiving the identification result of the state of the road surface from the integration determination ECU 72, the light control ECU 74 outputs an instruction to switch light with which the road surface is irradiated in accordance with the state of the road surface to the external light device 81.

For example, if the identification result indicates that there is snow on the road surface, the light control ECU 74 outputs an instruction to switch the color of light emitted by the external light device 81 to a chromatic color to the external light device 81. Specifically, when the current color of light emitted by the external light device 81 is white, the light control ECU 74 outputs an instruction to switch the color of light emitted by the external light device 81 to yellow to the external light device 81.

For example, if the identification result indicates that the road surface is wet, the light control ECU 74 outputs an instruction to switch to light having higher lightness or higher brightness than in a case where the road surface is dry to the external light device 81.

The external light device 81 which is the light emitting unit 4 switches the color, lightness, brightness, and the like of light with which a road surface is irradiated in accordance with the instruction output from the light control ECU 74.

As apparent from the above, according to the second embodiment, the road surface state identifying unit 5 for identifying the state of a road surface is included, and the control unit 6 outputs an instruction to switch light with which a road surface is irradiated in accordance with the state of the road surface identified by the road surface state identifying unit 5 to the light emitting unit 4. Therefore, even if the state of the road surface changes, deterioration in visibility of a light irradiation area of a road surface on a side of a rear wheel of a vehicle can be suppressed. This allows a driver to visually recognize the position of the rear wheel of the vehicle even if the state of the road surface changes.

### Third Embodiment

A third embodiment will describe an example in which a light emitting unit 4 emits light in such a manner that the shape of a light irradiation area changes with passage of time.

As in the first and second embodiments, when a light control ECU 74 outputs an instruction to irradiate a road surface on a side of a rear wheel of a vehicle with light to an external light device 81, the light control ECU 74 outputs an instruction to change the shape of a light irradiation area with passage of time to the external light device 81.

When receiving an instruction to irradiate a road surface on a side of a rear wheel of a vehicle with light from the light control ECU 74, the external light device 81 which is the light emitting unit 4 irradiates the road surface on the side of the rear wheel of the vehicle with light as in the first and second embodiments.

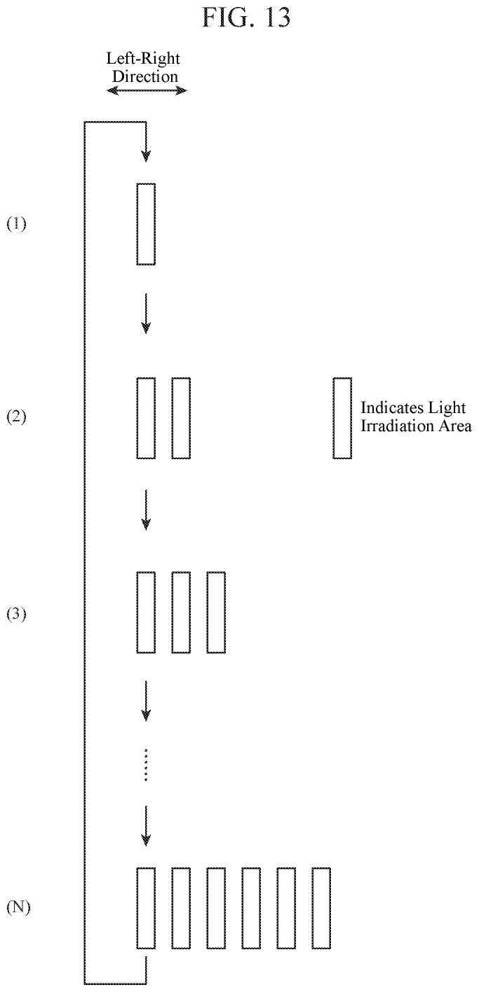

When receiving an instruction to change the shape of a light irradiation area with passage of time from the light control ECU 74, as illustrated in FIG. 13, the external light device 81 emits light in such a manner that the shape of an irradiation area changes with passage of time.

FIG. 13 is an explanatory diagram illustrating an example of a change in shape in a light irradiation area.

In the example of FIG. 13, the external light device 81 irradiates a side of a right rear wheel of a vehicle with light.

In the example of FIG. 13, the light irradiation area changes in such a manner that (1)→(2)→(3)→ . . . →(N)→(1)→(2)→(3)→ . . . →(N).

By changing the shape of the irradiation area with passage of time as illustrated in FIG. 13, it is possible to call attention to pedestrians or other vehicles present around the vehicle. Furthermore, it is possible to notify pedestrians or other vehicles present around the vehicle of a traveling direction or the like of the vehicle.

Here, an example in which the shape of the light irradiation area changes as illustrated in FIG. 13 is illustrated, but this is merely an example, and it goes without saying that the shape of the irradiation area may change so as to be different from that in FIG. 13.

The third embodiment illustrates an example in which the external light device 81 which is the light emitting unit 4 emits light in such a manner that the shape of the light irradiation area changes with passage of time, but the external light device 81 may emit light in such a manner that the color of light changes with passage of time.

For example, the color to be emitted by the external light device 81 may change in such a manner that white→yellow→orange→red→ . . . →white.

As apparent from the above, according to the third embodiment, the light emitting unit 4 emits light in such a manner that the shape of the light irradiation area or the color of the light changes with passage of time. Therefore, it is possible to call attention to pedestrians or other vehicles present around the vehicle.

Note that the present invention can freely combine the embodiments to each other, modify any constituent element in each of the embodiments, or omit any constituent element in each of the embodiments within the scope of the invention.

### INDUSTRIAL APPLICABILITY

The present invention is suitable for a rear wheel position indicator for irradiating a road surface on a side of a rear wheel of a vehicle with light.

### REFERENCE SIGNS LIST

1: Direction indication switch,
2: Traveling direction detecting unit,
3: Control unit,
4: Light emitting unit,
4a: Left side light emitting unit,
4b: Right side light emitting unit,
5: Road surface state identifying unit,
6: Control unit,
11: Traveling direction detecting circuit,
12: Control circuit,
13: Road surface state identifying circuit,
31: Vehicle speed sensor,
32: Steering angle sensor,
33: Accelerator sensor,
34: Brake sensor,
35: Shift sensor,
36: Blinker sensor,
37: Hazard sensor,
38: Wiper sensor,
39: Light sensor,
40: Button,
41: Door open/close sensor,
42: Driver camera,
43: Seating sensor,
44: Acceleration sensor,
45: Angular velocity sensor,
46: GPS device,
47: Navigation system,
48: Out-of-vehicle camera,
49: Out-of-vehicle sensor,
50: Illuminance sensor,
51: Overall control ECU,
52: Processor,
53: ROM,
54: RAM,
61: Engine,
62: Transmission,
63: Brake actuator,
64: Steering actuator,
65: Blinker,
66: HUD,
67: Headlight device,
67a: Headlight driver,
67b: Headlight,
71: Lighting control device,
72: Integration determination ECU,
72a: Processor,
72b: ROM,
72c: RAM,
73: Wireless communication device,
73a: Antenna,
73b: Transmitting unit,
73c: Receiving unit,
74: Light control ECU,
74a: Processor,
74b: ROM,
74c: RAM,
81 and 82: External light device,
81a and 82a: External light driver,
81b and 82b: External light set,
83: Projector device,
83a: Projector driver,
83b: Projector,
84: Body light device,
84a: Body light driver, and
84b: Body light.

1. A rear wheel position indicator comprising a light emitting device to irradiate a road surface on a side of a rear wheel of a vehicle with light, wherein
a light irradiation area by the light emitting device is at least a planar area extending in a front-rear direction of the vehicle, and the length of the light irradiation area in the front-rear direction of the vehicle is substantially the same as the length of the radius of the rear wheel.

2. The rear wheel position indicator according to claim 1, wherein the light irradiation area by the light emitting device is a planar area extending in the front-rear direction of the vehicle and extending in a left-right direction of the vehicle.

3. The rear wheel position indicator according to claim 1, wherein a shape of the light irradiation area by the light emitting device is different from a shape of a light irradiation area by a marker light which may be mounted on a side surface of the vehicle.

4. The rear wheel position indicator according to claim 1, further comprising:
a traveling direction detecting circuitry to detect a traveling direction of the vehicle; and
a control circuitry to output an instruction to irradiate a road surface on a side of a left rear wheel of the vehicle with light if a traveling direction detected by the traveling direction detecting circuitry is a left direction, and to output an instruction to irradiate a road surface on a side of a right rear wheel of the vehicle with light if the traveling direction is a right direction, wherein
the light emitting device irradiates the road surface on the side of the left or right rear wheel of the vehicle with light according to the instruction output from the control circuitry.

5. The rear wheel position indicator according to claim 1, further comprising:
a road surface state identifying circuitry to identify a state of the road surface; and
a control circuitry to control an instruction to switch light with which the road surface is irradiated according to a state of the road surface identified by the road surface state identifying circuitry, wherein
the light emitting device switches the light with which the road surface is irradiated according to the instruction output from the control circuitry.

6. The rear wheel position indicator according to claim 1, wherein the light emitting device emits light in such a manner that a shape of the light irradiation area or a color of the light changes with passage of time.
